(19) United States
(12) Patent Application Publication
(10) Pub. No.: US 2013/0290893 A1
(43) Pub. Date: Oct. 31, 2013

(54) METHODS AND APPARATUS FOR SYSTEM PERFORMANCE MONITORING

(71) Applicants: Sebastien Cabaniols, Echirolles (FR); David Eager, Charvil (GB); Clement Poulain, Grenoble (FR)

(72) Inventors: Sebastien Cabaniols, Echirolles (FR); David Eager, Charvil (GB); Clement Poulain, Grenoble (FR)

(21) Appl. No.: 13/458,506

(22) Filed: Apr. 27, 2012

(51) Int. Cl. G06F 3/048

(52) U.S. Cl. 715/772

(57) ABSTRACT

Embodiments of the present invention provide a computer-implemented method for displaying system performance data, comprising displaying a performance display object (PDO), wherein the PDO is a three-dimensional object, displaying a plurality of performance items arranged about the PDO, wherein each performance item is a three dimensional object having at least one characteristic indicative of a performance of one or more associated system components.

It is frequently desired to monitor the performance of a system, such as the performance of a computer system or a plurality of computer systems. To monitor the performance of the system it is often useful to display a graphical representation of one or more system performance metrics. Such metrics may include, for example, CPU load or temperature. With computer systems becoming increasingly complex, for example including growing numbers of CPUs, it is becoming increasingly difficult to monitor the performance of complex systems.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying figures, in which:

FIG. 1 shows a screenshot of a graphical user interface according to an embodiment of the invention;

FIG. 2 shows a schematic representation of an end view of a parameter display object according to an embodiment of the invention; and

FIG. 3 shows a schematic representation of a plan view of the parameter display object according to an embodiment of the invention; and

FIG. 4 shows a method according to an embodiment of the invention.

### DETAILED DESCRIPTION OF EMBODIMENTS OF THE INVENTION

An embodiment of the invention will be explained with reference to a graphical user interface which is provided for displaying one or more performance metrics of a computer system. The computer system is formed by a plurality of computing units. Each computing unit may be a networked computer which may include one or more CPUs. Thus each computing unit in the computer system has at least one associated performance metric. The computer system may comprise tens, hundreds or thousands of computing units and, consequently, the number of associated performance metrics may be large. The graphical user interface conveniently displays the performance metrics of the computing units allowing a user to simultaneously visualise current and historical performance of the computer system.

It will be realised that embodiments of the invention are not limited to displaying performance metrics of computer systems, but may also be used to display performance metrics associated with, for example, industrial processes and other time variant data sets. In this sense, time variant is understood to mean a plurality of datasets wherein each dataset represents a plurality of performance metrics at a particular time or over a period of time. Embodiments of the present invention may be particularly useful for displaying the performance of large-scale computer systems, such as those incorporating large numbers, e.g. hundreds or thousands, of computing units.

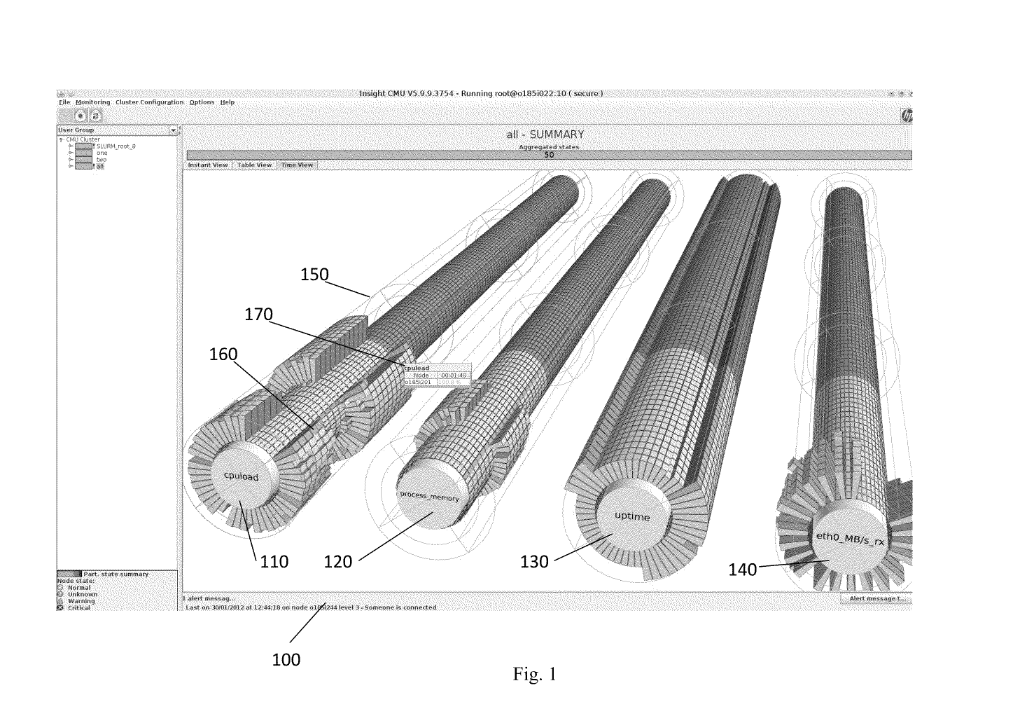

FIG. 1 illustrates a graphical user interface, denoted generally as 100, according to an embodiment of the invention.

The graphical user interface (GUI) 100 shown in FIG. 1 comprises a plurality of three dimensional performance display objects (PDOs) 110, 120, 130, 140 according to an embodiment of the invention. In the embodiment shown in FIG. 1 the GUI 100 is configured to display four PDOs 110, 120, 130, 140, although it will be realised that embodiments of the GUI 100 may display one or more PDOs. Each PDO 110, 120, 130, 140 dynamically displays a performance metric of the computer system, as will be explained. In the exemplary embodiment of FIG. 1, a first PDO 110 indicates CPU load in the computer system, a second PDO indicates process memory, a third PDO 130 indicates operational time and a fourth PDO 140 indicates network bandwidth usage. It will be realised that the performance metric associated with each PDO in FIG. 1 is merely illustrative and that other metrics may be displayed, such as temperature.

The PDOs 110, 120, 130, 140 in FIG. 1 are displayed by the GUI 100 in perspective view such that a user may see a most recent dataset alongside historic datasets, as will be explained. In this sense, the term dataset is understood to mean performance metrics of one or more computing units within the computer system. A viewpoint of the user with respect to the PDOs 110, 120, 130, 140 may be changed to enable the user to view datasets of interest.

A most-recent dataset representing a current performance of the computer system is displayed at a foremost end of each PDO 110, 120, 130, 140 whilst an oldest dataset is represented furthest from the user's viewpoint. As operation of the GUI progresses datasets are sequentially moved along each PDO 110, 120, 130, 140 to allow a newest dataset to be added to the foremost end of each PDO. Datasets are moved toward a distal end of each PDO 110, 120, 130, 140. Datasets reaching the distal end of the PDO 110, 120, 130, 140 are removed from the GUI.

It will be noted that data values are not present along the entire length of each PDO 110, 120, 130, 140 in FIG. 1. This is due to the system whose performance the GUI is monitoring being inactive for a period of monitoring by the GUI.

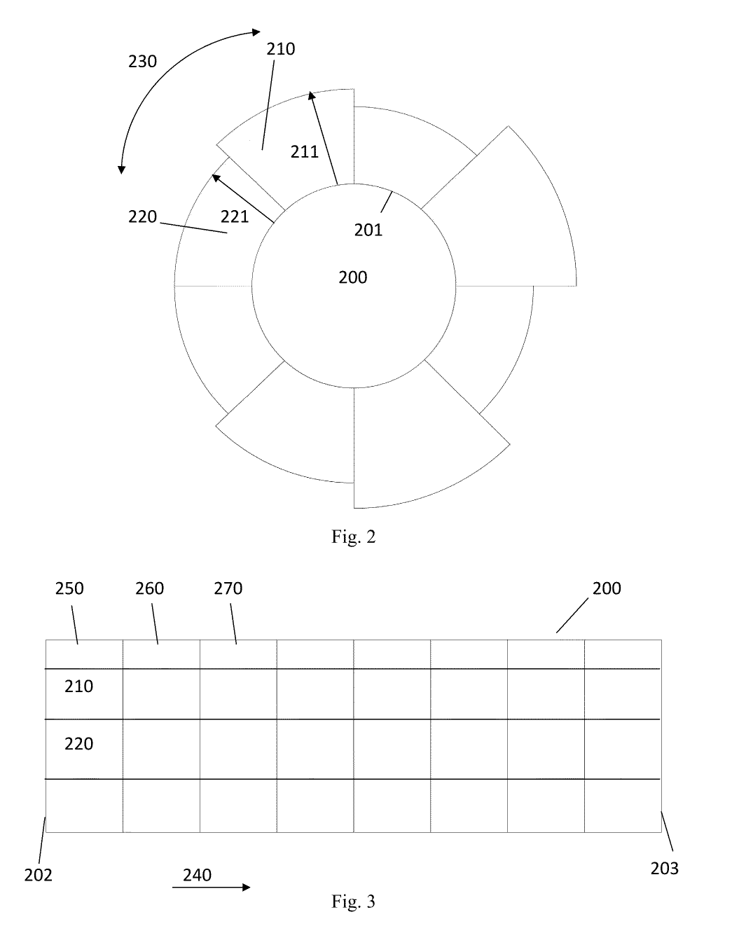

Operation of an exemplary PDO 200, such as the first PDO 110, will now be explained with reference to FIGS. 2 and 3.

Each PDO 200 is a three dimensional object having at least one surface upon which three dimensional performance items 210, 220 indicative of the performance of computing units are displayed. The PDO 200 is an elongate object. It will be noted that only two of the performance items displayed on the PDO 200 are indicated in FIG. 2 with reference numerals for clarity. In the exemplary embodiment, the PDO 200 is cylindrically shaped. However, in other embodiments, the PDO 200 may be rectangular or otherwise shaped. The performance items 210, 220 are displayed extending outward from a major (side) outer surface 201 of the PDO 200. Performance items may be arranged to extend outward from one or more side surfaces of the PDO 200. As shown in FIGS. 1-3 where the PDO 200 is cylindrical the performance items 210, 220 extend outward from the outer curved side surface of the PDO. In use of the GUI, the PDO 200 may be manipulated by the user to allow a convenient view of the desired performance items. The manipulation may include rotating the PDO 200 such that performance items 210, 220 relevant to a desired one or more computing units are visible to the user, or altering the current viewpoint of the PDO 200. Furthermore, one or more performance items 210, 220 may be selected by the user such that the GUI 100 provides further information regarding those performance items and the one or more computing units associated therewith. Some embodiments further allow the user to interact with or control the computing units associated with a selected performance item 210, 220.

The PDO 200 has a first axis 230 along which performance items 210, 220 are aligned to form a dataset indicative of the performance of the computer system at a particular time or over a period of time, as will be explained. In the embodiment of FIGS. 1-3, the first axis 230 is arranged radially around the PDO 200. As such, performance items 210, 220 aligned in the first axis 230 represent a dataset indicative of the plurality of computing units at that time.

The performance items 210, 220 are generally rectangular shaped and extend outward from the circumferential surface 201 of the PDO 200. The performance items may be shaped as a truncated wedge such that adjacent performance 210, 220 items closely fit together. The performance items are displayed about the PDO in three dimensions, as shown in FIG. 1. In some embodiments, the performance items 210, 220 are shaped to match the surface of the PDO and to closely fit against adjacent PDOs 210, 220. As shown in FIG. 2 the performance items 210, 220 may be shaped to abut each other. However, in some embodiments, as shown in FIG. 1 with reference to the fourth PDO 140, the performance items may be spaced around the circumference of the PDO 140 i.e. with a gap existing between adjacent performance items.

One or more characteristics of each performance item are indicative of the performance metric of associated computing units. In the embodiment shown in FIG. 2, a height 211, 221 or outward extent of each performance item 210, 220 from the surface 201 of the PDO 200 is indicative of the performance of a respective one or more computing units in the computer system. For example, a performance item having a height of 0 may indicate a CPU load of 0 whilst a performance item having a relative extent of 100% may indicate a maximally loaded CPU. Thus the performance item 210 indicates a greater CPU load than the performance item 220. As shown in FIG. 1, a wireframe 150 may be present around each PDO 110, 120, 130, 140 to indicate a maximum level or outward extent of the performance item, for example a CPU load of 100%.

As noted above, the dataset of performance items 210, 220 aligned in the first axis 230 radially around the PDO 200 indicates a state of the computer system at a particular time or over a period of time. In the example PDO 200 shown in FIG. 2, eight performance items 210, 220 are arranged around the PDO 200. Each performance item 210, 220 may indicate a performance metric of a corresponding computing unit. For example, in the case of the first PDO 110 shown in FIG. 1, the performance metric is the load on a respective CPU. Thus the first performance item 210 may indicate the CPU load on a corresponding CPU of the computer system. However, as will be explained, in some embodiments, a performance item 210, 220 may indicate an aggregated metric for a plurality of computing units in the computer system. The plurality of computing units may be a subset of the computing units in the computer system.

FIG. 3 shows a plan or side view of the PDO 200. The PDO 200 comprises a head end 202 and a tail end 203. Datasets indicative of the performance of the computer system at various time intervals or time steps are arranged in a second axis 240 of the PDO 200. The second axis 240 therefore represents time. The second axis 240 is aligned with a major axis of the PDO 200. The head end 202 of the PDO 200 is arranged in the GUI 100 to be closest to the user. A label may be presented to the user on the head-end 202 face of the PDO 200, as shown in FIG. 1, wherein the label is indicative of the performance metric represented by the PDO 200. Datasets from successively older time steps are presented along the PDO 200 toward the tail end 203.

A most recent dataset 250 formed by a plurality of performance items 210, 220 indicative of the most recent performance of the computer system is located nearest the head end 202. Further datasets 260, 270 (only two of which are labelled for clarity) are arranged along the PDO 200 in the second axis 240 to indicate the performance state of the computer system at increasingly older time steps. Thus datasets approaching the tail end 203 of the PDO indicate successively older performance states of the computer system. Performance items 210, 220 aligned in the second axis 240 along the PDO 200 represent a historical performance of the respective one or more computing units of the computer system. For example, where the GUI 100 is configured such that each performance item 210, 220 represents the performance metric of one computing unit the historical performance of the computing unit is indicated by performance items aligned along the PDO 200 in the second axis 240. Thus the PDO 200 displays a series of datasets 250, 260, 270 arranged in the second axis 240. Datasets may be moved along the PDO 200 at each timestep to allow the introduction of a current dataset of performance items 210, 220 at the head 202 of the PDO.

As explained above, in some embodiments each performance item 210, 220 may indicate a performance metric, such as CPU load, memory, operational time, etc., of a corresponding individual computing unit in the computer system. However the PDO 200 may be configured to indicate performance metrics of more computing units than performance items arranged around the PDO 200. For example, the PDO 200 shown in FIGS. 2 and 3 comprises eight performance items around its periphery. Whilst the performance items 210, 220 may indicate the performance of eight computing units in a 1:1 relationship, each performance item 210, 220 may indicate the performance metric of more than one computing unit in a 1:>1 relationship. In order for the performance item 210, 220 to represent the performance of more than one computing unit in the computer system, the performance metrics associated with a plurality of computing units are aggregated such that a corresponding performance item is indicative of the aggregate performance of the computing units. The performance metrics may be aggregated in a variety of different ways which may be configured by an administrator or user of the GUI 100.

Performance metrics may be aggregated in one embodiment to represent an average performance metric of a plurality of computing units. For example, each performance item 210, 220 may indicate an average performance of a plurality of computing units in the computer system. In other embodiments, each performance item 210, 220 may indicate a minimum or maximum performance metric of the plurality of computing units. For example, the performance item 210 may indicate the maximum CPU load of a maximally loaded computing unit from amongst a selected plurality of computing units in the computer system. The representation of the performance of more than one computing unit by each performance item 210, 220 may be known as space aggregation since space around the periphery of the PDO 200 is saved by aggregating performance metrics of a plurality of computing units.

As explained above, each data set 250, 260, 270 of performance items 210, 220 is indicative of the performance metrics in the computer system at a particular time. The GUI 100 may be configured such that a PDO, such as PDO 200 shown in FIGS. 2 and 3, displays datasets indicative of the computer system performance over a specified monitoring period of time, such as five minutes. The PDO 200 is further configured to display a dataset indicative of the performance of the computing units in the computer system at a specified time-step during the time period. The time-step may be ten seconds or other value chosen by the user. It will be realised that the monitoring period and display time-step are merely exemplary. Thus, based on these example figures, a dataset 250, 260, 270 of performance items is displayed every 10 seconds indicative of the performance metrics in the computer system at that time over the monitoring period of five minutes. After the GUI has been operational for the monitoring period or longer, thirty datasets (6 datasets per minute for five minutes) will be displayed along the PDO 200 from the head end 202 to the tail end 203. A new dataset is added at every time-step period to the head end 202 of the PDO 200 by moving existing displayed datasets along the PDO 200 toward the tail end 203 in the direction of the second axis 240. Each dataset 250, 260, 270 may abut adjacent datasets in the second axis 240 as shown in FIG. 3.

In some embodiments, the GUI 100 may be configured such that each dataset 250, 260, 270 is indicative of the performance of the computer system at a plurality of time steps. For example, if the selected number of time steps is greater than a display resolution of a device displaying the GUI, then datasets may be aggregated in the second axis. For example, each dataset may be configured to be indicative of performance at more than one time step by averaging the performance metrics over the plurality of time steps. Each dataset may represent the average, maximum or minimum performance metric over five time steps, for example.

In some embodiments of the invention the number of time steps represented by each dataset varies along an axis of the PDO 200. In particular, the number of time steps represented by each dataset may change at a point along the second axis 240 of the PDO 200. For example, the PDO 200 may be configured to display a predetermined number of datasets at the at the head end 202 of the PDO 200 each representing a predetermined number of time steps. For example, 10 datasets 250, 260, 270 proximal to the head end 202 of the PDO 200 may each represent a performance metric at each time step, such as 10 seconds. However, the remaining datasets proximal to the tail end 203 may each represent the performance metric at a greater number of time steps than the datasets proximal to the head end 202. For example, the remaining datasets may each represent the performance metric over more than one time step e.g. over 6 time steps or 1 minute in an aggregated manner, as explained above. In this way each of the older datasets displayed on the PDO 200 may represent an average performance metric over 1 minute, whilst the most recent datasets each represent a performance metric at 10 second intervals. The datasets may be distinguished by different display colours indicative of the respective aggregation and non-aggregation.

Referring again to FIG. 1, it will be noted that a series of performance items 160 aligned in the second axis 240 of each PDO 110, 120, 130, 140 are highlighted. The highlighted performance items 160 may indicate performance items on each PDO 110, 120, 130, 140 from a selected computing unit in the computer system to aid reference between the plurality of PDOs 110, 120, 130, 140. A series of performance items may be selected by the user in order to display further information representative of those performance items. FIG. 1 indicates a dialog box 170 which is provided in the GUI to textually provide further information to the user regarding the highlighted performance items 160. The dialog box 170 may provide an indication of an identity of the one or more computing units represented by the performance items 160 and a textual indication of the value of the current performance item, such as CPU load.

The user may also interact with computing units using the GUI 100. For example, one or more computing units represented by the highlighted series of performance items 160 shown in FIG. 1 may be controlled responsive to the highlighting. For example, the computing units may be controlled to reduce a number of processes operational on those computing units, thereby reducing the CPU load.

In some embodiments, where each performance item 210, 220 is indicative of the performance of more than one computing unit, first and second PDOs may represent the same performance metric. The first PDO 110 may display performance items each indicative of a performance metric of a plurality of computing units. When the user highlights a series of performance items on the first PDO, such as the highlighted series 160 shown in FIG. 1, the second PDO is then arranged to display a dataset of performance items each indicative of fewer computing units than the first PDO. For example, the second PDO 120 may display a plurality of performance items each indicative of the performance metric of one computing unit.

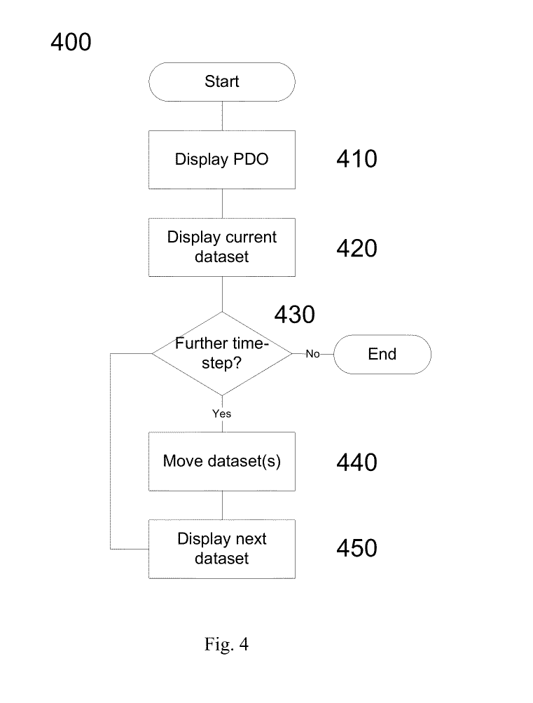

A method 400 according to an embodiment of the invention will now be explained with reference to FIG. 4. The method 400 may be performed by the GUI 100 shown in FIG. 1 which is executed by a computer.

In step 410 one or more PDOs 110, 120, 130, 140 are displayed. The PDOs 110, 120, 130, 140 may be displayed in the GUI 100 as shown in FIG. 1. Each PDO 110, 120, 130, 140 is configured to display a respective performance metric of the computer system.

In step 420 a dataset is displayed as a plurality of performance items 210, 220 each indicative of a performance metric associated with one or more computing units. For example, each performance item 210, 220 may indicate a CPU load on a respective computing unit of the computer system. One or more characteristics of each performance item 210, 220 is determined to represent the performance metric, such as the height or outward extent of each performance item 210, 220. The dataset is displayed at the head 202 of the PDO 200.

In step 430 it is determined whether a time step has elapsed since the display of the previous dataset of performance items. For example, the time-step may be 10 seconds as previously described, although other time step durations may be chosen. A maximum number of time-steps for which to display datasets may be configured in the GUI. If the selected number of time-steps has elapsed, then the method ends. Otherwise, once the time step has elapsed the method moves to step 440 wherein existing datasets displayed about the PDO 110, 120, 130, 140 are moved. The datasets are moved toward the tail 203 end of the PDO to allow the display of a next or nearest dataset at the head 202 end.

In step 450 a next dataset formed by a plurality of performance items 210, 220 indicative of the most recent performance metrics of the computing units is displayed. The dataset is displayed at the head 202 of the PDO. The method then returns to step 430 where it is again determined whether a further time step has elapsed.

The method described above can be accomplished by a computer program product comprising a computer readable storage medium having computer usable program code embodied therewith that, when executed, performs the above method.

The GUI described above may be displayed on a computing device, such as a computer or portable computing device e.g. tablet, laptop computer or other hand held computing device having a display for displaying the GUI thereon. The computer program code for accomplishing the above method is stored in a memory of the computing device and executed by a processor of the computing device to provide the GUI to the user.

Embodiments of the invention provide a method of representing performance metrics of a computer system in a convenient manner to allow a user to asses a current and historic performance of the computer system.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A computer-implemented method for displaying system performance data, comprising:
displaying a performance display object (PDO), wherein the PDO is a three-dimensional object;
displaying a plurality of performance items arranged about the PDO, wherein each performance item is a three dimensional object having at least one characteristic indicative of a performance of one or more associated system components.

2. The method of claim 1, wherein the plurality of performance items form a dataset indicative of the performance of the one or more associated system components at a point in time.

3. The method of claim 1, wherein the plurality of performance items is indicative of the performance of the one or more associated system components over a period of time.

4. The method of claim 1, wherein the plurality of performance items are arranged about the PDO in a first axis.

5. The method of claim 1, comprising:
moving the plurality of performance items along the PDO in a second axis;
displaying a second plurality of performance items about the PDO.

6. The method of claim 1, wherein the at least one characteristic indicative of the performance of the one or more associated system components comprises a height of each performance item.

7. The method of claim 1, wherein each performance item is indicative of an aggregated performance of a plurality of associated system components.

8. The method of claim 1, comprising rotating the PDO responsive to a user input.

9. A computer system, comprising:
a plurality of computing units each having an associated performance metric;
a monitor computing device arranged to receive information indicative of the performance metrics from the plurality of computing units, wherein the monitor computer is arranged to display on a display device a three dimensional performance display object PDO and a dataset comprising a plurality of performance items arranged around the PDO, wherein each performance item has at least one characteristic indicative of the performance metrics associated with one or more of the plurality of computing units.

10. The computer system of claim 9, wherein the dataset is indicative of the performance metrics associated with one or more computing units at a point in time.

11. The computer system of claim 9, wherein the dataset is indicative of the performance metrics associated with one or more computing units over a predetermined period of time.

12. The computer system of claim 11, wherein the dataset is indicative of an average performance metric associated with one or more computing units over the predetermined period of time.

13. The computer system of claim 9, where each performance item is indicative of an aggregate of performance metrics associated with a plurality of the computing units.

14. The computer system of claim 13, wherein the aggregate is one of an average, a maximum and a minimum.

15. A graphical user interface (GUI) output by a display device of a computing entity for displaying system performance data, comprising:
a three dimensional performance display object (PDO);
at least one dataset comprising a plurality of three dimensional performance items arranged in a first axis around the PDO, wherein each performance item has one or more characteristics indicative of a performance metric of one or more associated system components at a first point in time.

16. The GUI of claim 15, wherein the GUI is arranged to:
move the first dataset in a second axis; and
display a second dataset comprising a plurality of three dimensional performance items each having at least one characteristic indicative of the system parameter at a second point in time.

17. The GUI of claim 15, wherein:
the GUI is arranged to receive an input from the user to select one or more performance items; and
the GUI is arranged to receive an input from the user to control an operational parameter of one or more system components associated with the selected performance items.
